(19) United States
(12) Patent Application Publication
(10) Pub. No.: US 2024/0296397 A1
(43) Pub. Date: Sep. 5, 2024

(54) METHOD AND SYSTEM FOR REDUCING UNDERSTAFFING CONDITIONS BY ENABLING SCHEDULING OF A FLEXIBLE ACTIVITY REQUEST IN A WORKFORCE MANAGEMENT (WFM) SYSTEM

(71) Applicant: NICE LTD., Ra'anana (IL)

(72) Inventors: Kanchan VASNANI, Niranjanpur (IN); Richa DEO, Jamshepur (IN); Vaibhav CHOBE, Pune (IN)

(21) Appl. No.: 18/117,451

(22) Filed: Mar. 5, 2023

(51) Int. Cl. G06Q 10/0631

(52) U.S. Cl. CPC G06Q 10/063118

(57) ABSTRACT

A computerized-method for reducing understaffing conditions by enabling scheduling of a flexible-activity-request in a WFM system. The computerized-method includes operating a Flexible-Activity-Requestor module to enable an agent to enter a date-range for the flexible-activity-request. Receiving an agent date-range to be forwarded to a Schedule-Requests-Management (SRM) system and upon manager approval stored in a database. Generating one or more schedules to be assigned to one or more agents, forwarding the generated schedules to a Schedule-Manager MS. Having the SRM system retrieve preferences of future activity requests from the database and forward it to the Schedule-Manager MS and operating a scheduler MS to select a date which is in the entered date-range for each future activity request based on the retrieved preferences of future activity requests; and staffing plans retrieved from a staffing data database. Sending notifications to agents as to the selected date of each future activity request.

### TECHNICAL FIELD

The present disclosure relates to method and system for scheduling a flexible activity request in a workforce management system.

### BACKGROUND

In contact center systems, such as Workforce Management (WFM) systems, there are some activities which are requested by the agents to take place during an assigned schedule, that are currently determined in a fixed manner and do not allow agents any flexibility or leeway in their schedules.

Accordingly, there is a need for a technical solution for adding flexibility to agents schedule between any given date or time defined by them. For example, enabling an agent to have self-paced training part of the compliance requirement by the organization be scheduled anytime during a preferred date and time range.

Furthermore, from staffing levels perspective in the contact center, when an agent submits a fixed date and time for an activity request when a schedule haven't been published for manager approval, then the manager may not have sufficient information to determine if on approval of the activity request, it may result in understaffing conditions or in understaffing conditions getting worsen. Hence, the manager may be less confident as to approving the date of the activity request having fixed date and time due to this uncertainty.

Therefore, there is a need for system and method for reducing understaffing conditions by enabling scheduling of a flexible activity request in a Workforce Management (WFM) system.

### SUMMARY

There is thus provided, in accordance with some embodiments of the present disclosure, a computerized-method for reducing understaffing conditions by enabling scheduling of a flexible activity request in a Workforce Management (WFM) system.

In accordance with some embodiments of the present disclosure, the computerized system may include: (i) operating a Flexible Activity Requestor (FAR) module to enable an agent to enter a date range for the flexible activity request via a Graphical User Interface (GUI); (ii) receiving agent date range for a future activity request to be forwarded to a Schedule Requests Management (SRM) system and upon manager approval stored in a database of agents preferences: (iii) generating one or more schedules in a preconfigured period to be assigned to one or more agents and forwarding the generated schedules to a Schedule Manager Microservice (MS); (iv) having the SRM system retrieve preferences of future activity requests in the preconfigured period from the database of agents preferences and forward it to the Schedule Manager MS; (v) operating a scheduler MS to select a date which is in the entered date range for each future activity request of the one or more future activity requests based on: a. the retrieved preferences of future activity requests; and b. staffing plans retrieved from a staffing data database; and (vi) sending notifications to agents as to the selected date of each future activity request of the one or more future activity requests. Each notification in the notifications may include the flexible activity request in the selected date in an assigned schedule, in the WFM system, thus, by taking into account staffing plans when selecting a date for an activity, reducing understaffing conditions in a contact center which results in increased wait time for customers.

Furthermore, in accordance with some embodiments of the present disclosure, the operating of the FAR module may be enabled by a selection of an option for the FAR module in a Graphical User Interface (GUI) that is associated to the FAR module.

Furthermore, in accordance with some embodiments of the present disclosure, the FAR module is configurable.

Furthermore, in accordance with some embodiments of the present disclosure, a future activity request may be selected from at least on of: (i) time-off; (ii) self-paced training; (iii) any other activity which requires one agent involvement.

Furthermore, in accordance with some embodiments of the present disclosure, the notifications may be sent by email messages to the agents.

Furthermore, in accordance with some embodiments of the present disclosure, the generating of the one or more schedules in the preconfigured period to be assigned to one or more agents is operated by the FAR module and may include for each agent that has one or more future activity requests in the preconfigured period which are stored in the database of agents preferences: (i) retrieving staffing data from the staffing data database for each schedule in the preconfigured period. said staffing data comprising a required number of agents and available agents; (ii) when the available agents for the staffing data is greater than the required number of agents for the staffing data for each schedule in the one or more schedules, then randomly selecting a date for each future activity request of the one or more future activity requests; (iii) when the available agents for the staffing data is lower than the required number of agents for the staffing data in one or more schedules, then randomly selecting a date that is in the date range for the flexible activity request and not in a date that the available agents for the staffing data is lower than the required number of agents for the staffing data, for the future activity request; (iv) when the available agents for the staffing data is lower than the required number of agents for the staffing data in all one or more schedules, then selecting a date that is in the date range for the flexible activity request and that is least understaffed for the future activity request.

Furthermore, in accordance with some embodiments of the present disclosure, each selected date for each future activity request is published in a related schedule via the GUI.

Furthermore, in accordance with some embodiments of the present disclosure, staffing data comprising at least one of: (i) scheduling unit group of agents; and (ii) one or more skills required for a schedule.

There is further provided, in accordance with some embodiments of the present invention, a computerized-system for understaffing conditions by enabling scheduling of a flexible activity request in a in a Workforce Management (WFM) system.

Furthermore, in accordance with some embodiments of the present disclosure, the computerized-system includes one or more processors, a database of agents preferences: a staffing data database, and a memory to store the database of agents preferences.

Furthermore, in accordance with some embodiments of the present disclosure, the selected date for the future activity request is embedded in the assigned schedule in the WFM system.

There is further provided, in accordance with some embodiments of the present disclosure. computerized-system for reducing understaffing conditions by enabling scheduling of a flexible activity request in a in a Workforce Management (WFM) system. The computerized-system for reducing understaffing conditions by enabling scheduling of a flexible activity request in a in a WFM system may include one or more processors, a database of agents preferences, a staffing data database, and a memory to store the plurality of databases.

Furthermore, in accordance with some embodiments of the present disclosure, the one or more processors may be configured to: (i) operate a Flexible Activity Requestor (FAR) module to enable an agent to enter a date range for the flexible activity request upon agent selection to operate an FAR module via a Graphical User Interface (GUI); (ii) receive agent date range for a future activity request to be forwarded to a Schedule Requests Management (SRM) system and upon manager approval stored in a database of agents preferences; (iii) generate one or more schedules in the preconfigured period to be assigned to one or more agents, and forwarding the generated schedules to Schedule Manager Microservice (MS); (iv) have the SRM system retrieve preferences of future activity requests in a preconfigured period from the database of agents preferences and forward it to the Schedule Manager MS; (v) operate a scheduler MS to select a date which is in the entered date range for each future activity request of the one or more future activity requests based on: a. the retrieved preferences of future activity requests; and b. staffing plans retrieved from the staffing data database; and (vi) send notifications to agents as to the selected date of each future activity request of the one or more future activity requests. Each notification in the notifications includes the flexible activity request in the selected date in an assigned schedule, thus, by taking into account staffing plans when selecting a date for an activity, reducing understaffing conditions in a contact center which results in increased wait time for customers.

### BRIEF DESCRIPTION OF THE DRAWINGS

In order for the present invention, to be better understood and for its practical applications to be appreciated, the following Figures are provided and referenced hereafter. It should be noted that the Figures are given as examples only and in no way limit the scope of the invention. Like components are denoted by like reference numerals.

FIG. 1 schematically illustrates a high-level diagram of a computerized-system for reducing understaffing conditions by enabling scheduling of a flexible activity request in a Workforce Management (WFM) system, in accordance with some embodiments of the present invention;

FIG. 2 is a schematic flowchart of a computerized-method for reducing understaffing conditions by enabling scheduling of a flexible activity request in a Workforce Management (WFM) system, in accordance with some embodiments of the present invention;

FIG. 3 is an example of a Graphical User Interface (GUI) having several activity requests presented to a manager with no agents requirements or schedules information, in accordance with some embodiments of the present invention;

FIG. 4 is a schematic flowchart of data flow of information between components in a computerized-system for reducing understaffing conditions by enabling scheduling of a flexible activity request in a WFM system, in accordance with some embodiments of the present invention;

FIG. 5 is an example of a GUI that enables an agent to enter a date range for the flexible activity request, in accordance with some embodiments of the present invention;

FIG. 6 is an example of a GUI for a manager to initiate a schedule generation, in accordance with some embodiments of the present invention;

FIG. 7 is a schematic flowchart of activity request submitted by an agent, in accordance with some embodiments of the present invention;

FIG. 8 is a schematic flowchart of schedule generation by a supervisor, in accordance with some embodiments of the present invention;

FIG. 9 is a Workforce Management system architecture diagram, in accordance with some embodiments of the present invention;

FIG. 10 is an example of a table of agents requirement in a date range, in accordance with some embodiments of the present invention; and

FIG. 11 is an example of a GUI that presents a schedule and an activity embedded therein, in accordance with some embodiments of the present invention.

### DETAILED DESCRIPTION

In the following detailed description, numerous specific details are set forth in order to provide a thorough understanding of the disclosure. However, it will be understood by those of ordinary skill in the art that the disclosure may be practiced without these specific details. In other instances, well-known methods, procedures, components, modules, units and/or circuits have not been described in detail so as not to obscure the disclosure.

Although embodiments of the disclosure are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium (e.g., a memory) that may store instructions to perform operations and/or processes.

Although embodiments of the disclosure are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently. Unless otherwise indicated, use of the conjunction “or” as used herein is to be understood as inclusive (any or all of the stated options).

The term “flexible activity request” as used herein, refers to an activity request to take place during a day or during specific hours during that day in not yet assigned schedule. The flexible activity request may be entered by an agent via a graphical User Interface (GUI) providing a range of dates. upon which the agent is indifferent or flexible as to any one date in the provided range of dates.

The term “schedule” as used herein, refers to a shift that an agent is assigned to and all tasks for the agents are included, each having a start time and end time during the shift. A task in such a schedule may be for example, attending incoming calls, operating outbound calls, breaks and the like.

According to some embodiments of the present disclosure, in a Workforce Management (WFM) system, in a contact center, an activity request, such as self-paced training or time-off, may be entered by an agent to take place before a schedule has been assigned to the agent. However, staffing level information, as to a specific date or schedule, may not be available for a supervisor or manager to make a decision if to approve the activity request. In some circumstances, an agent may be indifferent or flexible as to a day in a range of date and optionally the time, that the activity may take place, such that the date that the agent may operate the activity may be when the agent is less required, thus reducing understaffing conditions.

Therefore, there is a need for system and method for reducing understaffing conditions in a contact center by enabling scheduling of a flexible activity request in a WFM system.

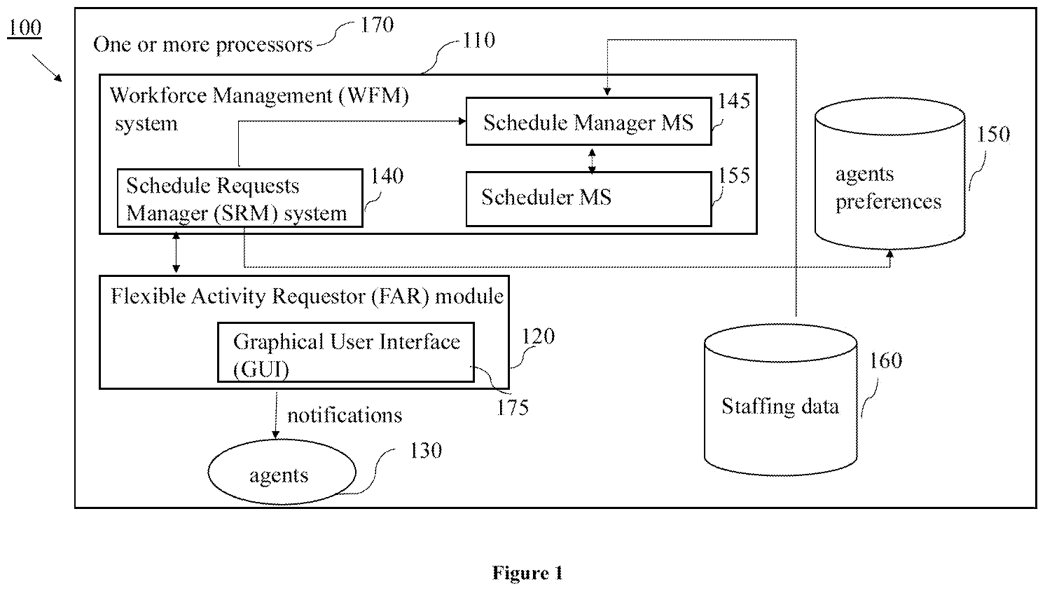

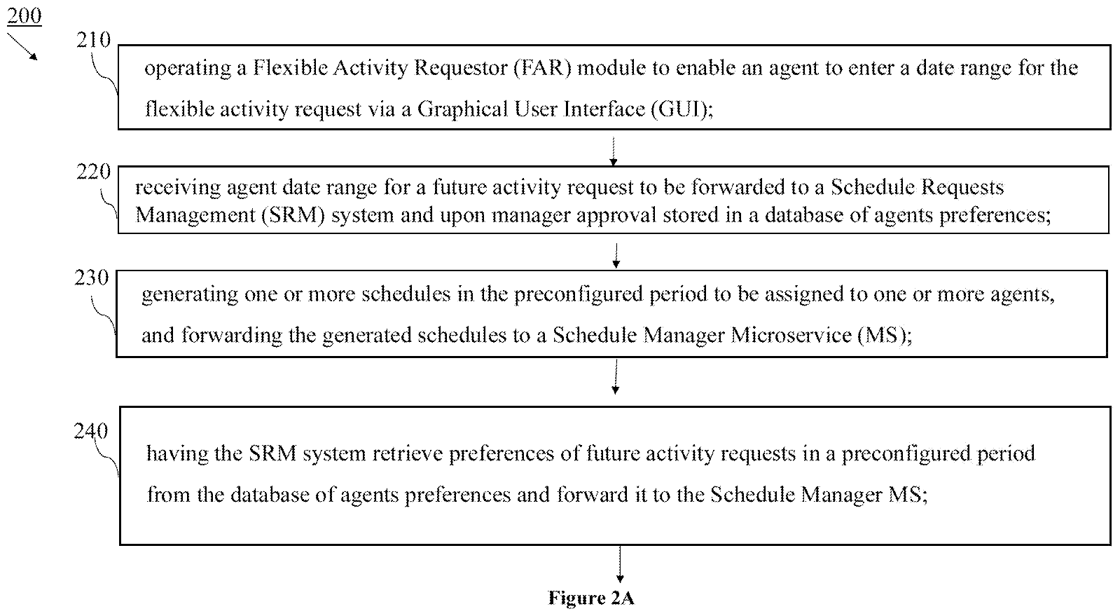

FIG. 1 schematically illustrates a high-level diagram of a computerized-system 100 for reducing understaffing conditions by enabling scheduling of a flexible activity request in a Workforce Management (WFM) system, in accordance with some embodiments of the present invention.

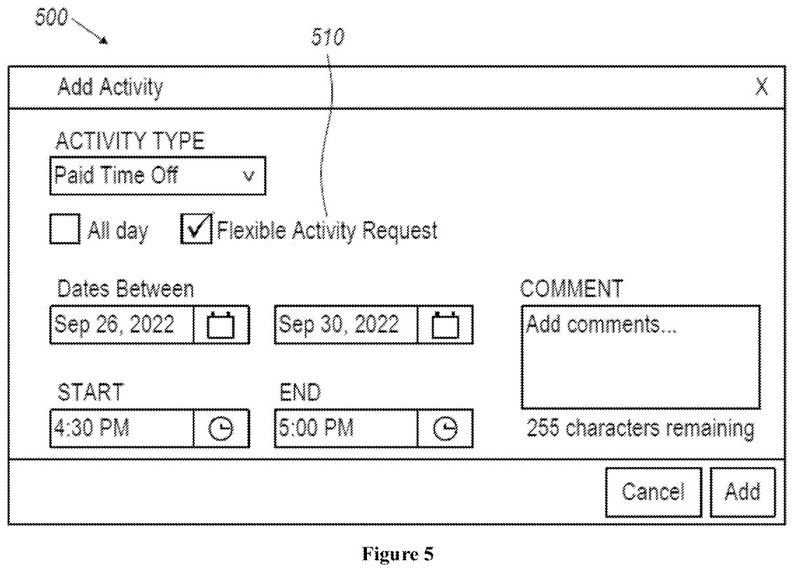

According to some embodiments of the present disclosure, a system, such as computerized-system 100, may provide an option to the agents to choose flexible scheduling at the time of placing an activity request during a schedule, that hasn't been generated yet. For example, via a Graphical User Interface (GUI), such as GUI 500 in FIG. 5, a module, such as Flexible Activity Requestor (FAR) module 120, may enable the agents to enter a date range and optionally time, for a future activity request, such as time-off or self-paced training and the like, via the GUI.

According to some embodiments of the present disclosure, prior to schedules generation in a Workforce Management (WFM) system, such as WFM system 110, an agent preference of the dates for scheduling the flexible activity may be considered, as well as the demand for agents taken from the staffing plans, such that these activities may be placed based on the best fit from the aspect of staffing level, during schedule generation process.

According to some embodiments of the present disclosure, the staffing plans may include staffing data, such as required number of agents for agents scheduling unit and required number of agents for agents skills.

According to some embodiments of the present disclosure, an agent may enter a date range for a flexible activity request, via a GUI, for example, such as GUI 500 in FIG. 5. The flexible activity request and the date range for it, may be forwarded to a system, such as Schedule Requests Management (SRM) system 140 and upon manager approval, it may be stored in a database, such as database of agents preferences 150, for later on consideration, during the schedule generation process, when the schedules are generated.

According to some embodiments of the present disclosure, after the schedules for a specific period may be generated, e.g., upon a user request via a GUI, such as GUI 600, the FAR module 120 may communicate with the Schedular MS 155 to select a date for the future activity request, and the generated schedules may be forwarded to a Schedule Manager Microservice (MS) 145.

According to some embodiments of the present disclosure, the SRM system 140 may retrieve preferences of future activity requests in the preconfigured period from the database of agents preferences 150 and may forward it to the Schedule Manager MS 145. The Schedule Manager MS 145 may communicate with a Scheduler MS 155 to forwards the retrieve preferences of future activity requests in the preconfigured period.

According to some embodiments of the present disclosure, the Scheduler MS 155 may be operated to select a date, i.e., a day, which is in the entered date range for each future activity request of the one or more future activity requests based on the retrieved preferences of future activity requests and staffing plans, which have been retrieved from a database, such as staffing data database 160.

According to some embodiments of the present disclosure, the selected date for the activity request may be sent, by notifications, to agents and optionally to the agents supervisor, which may include the future activity request on the selected date and optionally the time and also a display of the schedule and the date as it is embedded in the assigned schedule in the WFM system.

According to some embodiments of the present disclosure, by taking into account staffing plans and staffing data, by selecting a date for an activity for the agent during an assigned schedule, reducing understaffing conditions in a contact center which may result in increased wait time for customers.

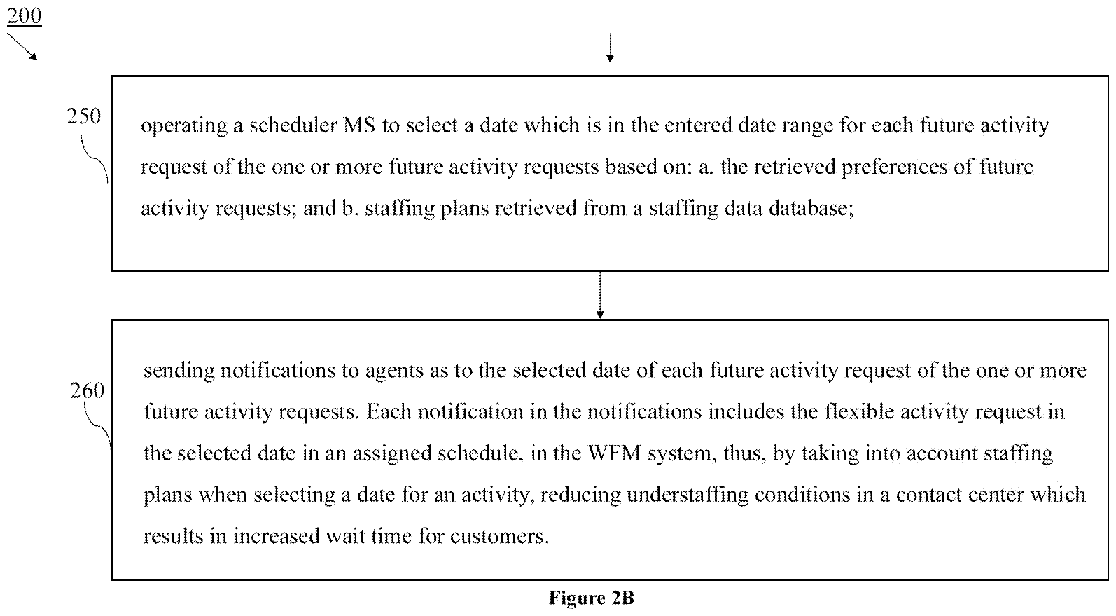

According to some embodiments of the present disclosure, computerized-system 100 may implement operations of a computerized-method, such as computerized-method for reducing understaffing conditions by enabling scheduling of a flexible activity request in a Workforce Management (WFM) system 200 in FIGS. 2A-2B.

According to some embodiments of the present disclosure, via a system, such as computerized-system 100, agents may have a flexibility to request future activities, which can be scheduled within a preferred date range. In computerized-system 100 a date for the future activity may be selected by Scheduler MS 155, such that the absence of the agent from the schedule to participate in the requested activity may minimize the impact on staffing levels during that period of time. Moreover, the confidence of the manager that approves the activity requests may be increased by knowing that the computerized-system may select a date in the date range that minimizes the negative impact on staffing levels.

According to some embodiments of the present disclosure, via a system, such as computerized-system 100, agents may have a higher probability for getting activity requests approved by a manager or supervisor which may increase Employee Satisfaction (ESAT). In such a system, staffing levels of the contact center may be optimal, which may also increase Customer Satisfaction (CSAT).

According to some embodiments of the present disclosure, notifications may be sent to agents as to the selected date of each future request of the one or more future activity requests. Each notification in the notifications may include the flexible activity request in the selected date in an assigned schedule in the WFM system 110, thus, by taking into account staffing plans when selecting a date for an activity, reducing understaffing conditions in a contact center which results in increased wait time for customers. The notifications may be sent by email messages to the agents or any other digital communication channel.

According to some embodiments of the present disclosure, taking into account staffing plans when selecting a date for an activity may be performed by comparing the staffing data, i.e., a required number of agents and available agents from the staffing data database for each schedule in the preconfigured period.

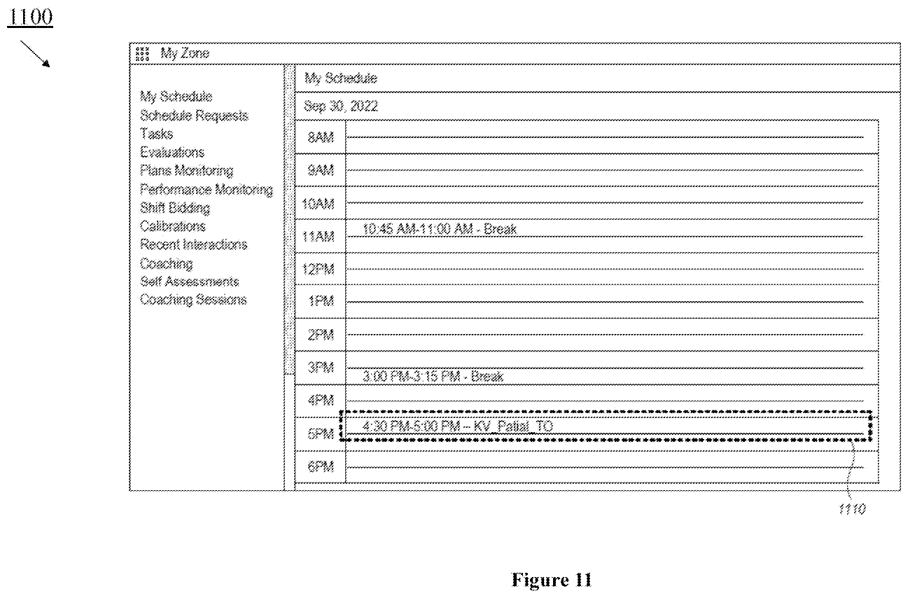

According to some embodiments of the present disclosure, the selected date and optionally time for the future activity request may be embedded in the assigned schedule in the WFM system 110, for example, as shown by element 1110 in GUI 1100 in FIG. 11.

According to some embodiments of the present disclosure, the operating of the FAR module 120 may be enabled by a selection of an option for the FAR module 120 in a GUI, such as GUI 175 that is associated to the FAR module 120, for example, as shown in GUI 500 in FIG. 5. The FAR module 120 may be configurable by a user when defining activities.

According to some embodiments of the present disclosure, the generating of the one or more schedules in the preconfigured period to be assigned to one or more agents may be operated by the Scheduler MS 155 and may include for each agent that has one or more future activity requests in the preconfigured period which are stored in the database of agents preferences a selected date in a range of dates for the activity.

According to some embodiments of the present disclosure, during the generating of the one or more schedules, staffing data from the staffing data database 160 for each schedule in the preconfigured period, may be also retrieved by the Schedule Manager MS 145. The staffing data may include a required number of agents and available agents. Staffing data may include at least one of: (i) scheduling unit group of agents; and (ii) one or more skills required for a schedule.

According to some embodiments of the present disclosure, when the number of available agents for the staffing data is greater than the required number of agents for the staffing data. for each schedule in the one or more schedules, then a date for each future activity request of the one or more future activity requests may be randomly selected. When the available number of agents for the staffing data is lower than the required number of agents for the staffing data in one or more schedules, then a date may be randomly selected that is in the date range for the flexible activity request and not in a date that the available agents for the staffing data is lower than the required number of agents for the staffing data, for the future activity request. When the available number of agents for the staffing data is lower than the required number of agents for the staffing data in all one or more schedules, then selecting a date that is in the date range for the flexible activity request and that is least understaffed for the future activity request.

According to some embodiments of the present disclosure, each selected date for each future activity request may be published in a related schedule, via a GUI, for example as shown in GUI 1100 by element 1110 in FIG. 11. The selected date for the future activity request may be embedded in the assigned schedule in the WFM system 110.

FIG. 2 is a schematic flowchart a computerized-method for reducing understaffing conditions by enabling scheduling of a flexible activity request in a Workforce Management (WFM) system, in accordance with some embodiments of the present invention

According to some embodiments of the present disclosure, operation 210 comprising operating a Flexible Activity Requestor (FAR) module to enable an agent to enter a date range for the flexible activity request via a Graphical User Interface (GUI). For example, such as GUI 175 in FIG. 1.

According to some embodiments of the present disclosure, operation 220 comprising receiving agent date range for a future activity request to be forwarded to a Schedule Requests Management (SRM) system and upon manager approval stored in a database of agents preferences. The SRM system may be for example, SRM system 140, in FIG. 1.

According to some embodiments of the present disclosure, operation 230 comprising generating one or more schedules in a preconfigured period to be assigned to one or more agents and forwarding the generated schedules to a Schedule Manager Microservice (MS). The Schedule Manager MS may be for example, Schedule Manager MS 145 in FIG. 1.

According to some embodiments of the present disclosure, operation 240 comprising having the SRM system retrieve preferences of future activity requests in the preconfigured period from the database of agents preferences and forward it to the Schedule Manager MS.

According to some embodiments of the present disclosure, operation 250 comprising operating a scheduler MS to select a date which is in the entered date range for each future activity request of the one or more future activity requests based on: a. the retrieved preferences of future activity requests; and b. staffing plans retrieved from a staffing data database. The Scheduler MS may be for example, Scheduler MS 155 in FIG. 1 and the staffing data database may be for example, staffing data database 160 in FIG. 1.

According to some embodiments of the present disclosure, operation 260 comprising sending notifications to agents as to the selected date of each future activity request of the one or more future activity requests. Each notification in the notifications includes the flexible activity request in the selected date in an assigned schedule, in the WFM system thus, by taking into account staffing plans when selecting a date for an activity, reducing understaffing conditions in a contact center which results in increased wait time for customers.

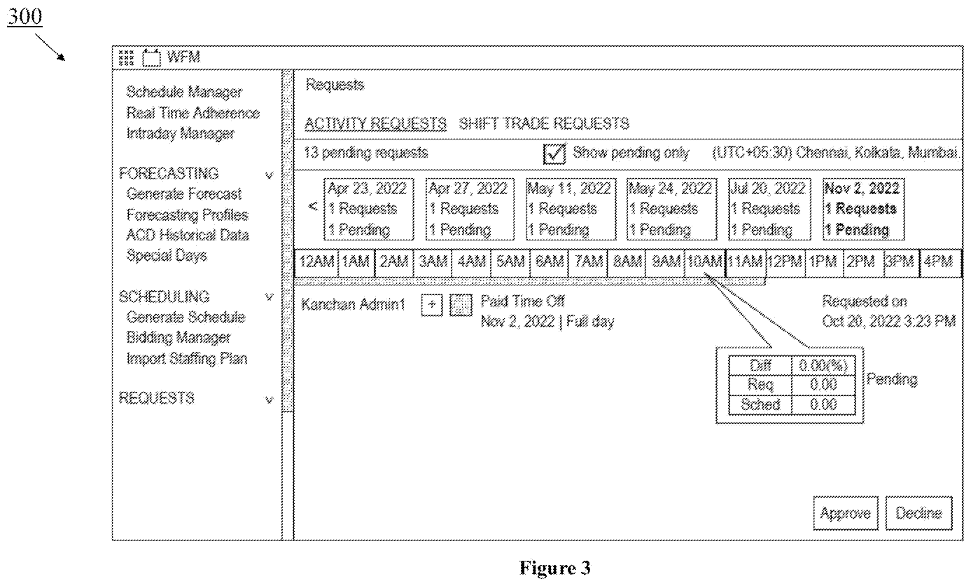

FIG. 3 is an example of a Graphical User Interface (GUI) 300 having several activity requests presented to a manager with no agents requirements or schedules information, in accordance with some embodiments of the present invention.

According to some embodiments of the present disclosure, there are some activities which are requested by the agents in a contact center, which can have flexibility to be added to their schedule between any given date or optionally time defined by them. For example, an agent may want to have a self-paced training part of the compliance requirement by the organization, be scheduled anytime during a preferred date and time range.

According to some embodiments of the present disclosure, for an unpublished day, i.e., a day that is not included in a generated and assigned schedule, if an agent submits a fixed date and time activity request for a manager approval, the manager may not have staffing level information to make a decision, such that if on approval of the agent request the contact center might get understaffed by one agent. Hence, the manager would not be confident on approving the regular activity request due to this uncertainty.

According to some embodiments of the present disclosure, a system, such as computerized-system 100 in FIG. 1, may operate to reduce understaffing conditions by enabling scheduling of a flexible activity request in a Workforce Management (WFM) system, such as WFM system 110 in FIG. 1, thus a manager may be more confident to approve agents activity requests.

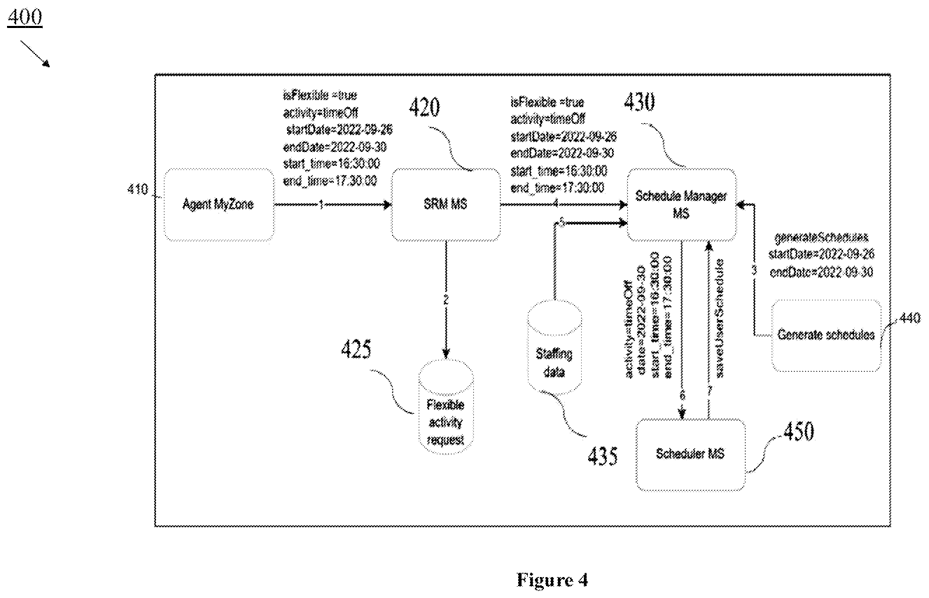

FIG. 4 is a schematic flowchart 400 of data flow of information between components in a computerized-system for reducing understaffing conditions by enabling scheduling of a flexible activity request in a WFM system, in accordance with some embodiments of the present invention.

According to some embodiments of the present disclosure, agent MyZone 410 may be a user interface for agents, which allows them to view their schedules, enter request for activities, such as time-off, shift trade, schedule change requests, and the like. The following features may be included in agent MyZone 410.

According to some embodiments of the present disclosure, (i) viewing schedules: agents can view their schedules, including the date, time, and activity they are scheduled to work on. They can also view the schedules of other agents and compare their schedules with others. (ii) requesting activities: agents can request to work on specific activities, such as overtime, flexible activities, or specific projects. These requests are sent to their managers for approval. (iii) requesting time-off where agents can request time-off, such as vacation, sick leave, or personal leave. These requests are sent to their managers for approval. (iv) requesting schedule changes where agents can request changes to their schedules, such as requesting to work on a different shift or on a different day. These requests are sent to their managers for approval. (v) requesting trade where agents can request to trade shifts with other agents. These requests are sent to their managers for approval. (vi) Message center where agents can also communicate with their managers, administrators and other agents through the message center in agent MyZone 410.

According to some embodiments of the present disclosure, in a system, such as computerized-system 100 in FIG. 1, agents may use agent MyZone 410 interface which may be operated by a module, such as FAR module 120 in FIG. 1 to submit a flexible activity request that may be handled by a system, such as Schedule Request Manager (SRM) system, 140 in FIG. 1. The SRM system may operate a microservice, such as SRM MS 420. A GUI to enter a date range for the flexible activity request may be for example, GUI 500 in FIG. 5, which may be included in agent MyZone 410 interface.

According to some embodiments of the present disclosure, agent MyZone 410 interface may provide agents with an interface to manage their schedules, request activities, such as time-off, shift trade and schedule shift changes. SRM MS 420 may streamline the process of requesting and managing schedules and may enable agents to take more control over their schedules and activities.

According to some embodiments of the present disclosure, a microservice, such as SRM MS 420 may be operated by an SRM system, such as SRM system 140 in FIG. 1, that allows agents to request changes to their schedules. It allows agents to make requests for changes to their schedules, such as requesting time off, requesting a change to their work schedule, or requesting to work on a specific activity.

According to some embodiments of the present disclosure, when an agent initiates a flexible activity request via the GUI, the request may be forwarded to the SRM MS 420. The request may include details about the isFlexibleActivityRequest flag, as it has been selected by the agent via the GUI, as shown for example, in FIG. 5. The GUI, such as GUI 500 in FIG. 5, may include an activity that the agent is requesting, such as the activity name, start date and end date for the activity, and optionally the start time and end time for the activity. These details may be used to determine the date range in which the agent wants this activity to be scheduled.

According to some embodiments of the present disclosure, the SRM MS 420 may store these details in a table, such as SCHEDULE_REQUEST table in a database such as flexibility activity request database 425 and such as agents preferences database 150 in FIG. 1, that is associated to it. This table may be used to keep track of all flexible activity requests made by agents. The SRM MS 420 may also keep track of the status of each request, such as whether it is pending, approved, or denied.

According to some embodiments of the present disclosure, in a system, such as computerized-system 100 in FIG. 1, after schedules are generated by generate schedules 440 component, a microservice, such as Schedule Manager MS 430, may fetch the flexible activity request details from the SRM system. The Schedule Manager MS 430 may send the retrieved data and the staffing data to a Scheduler MS 450, such as Scheduler MS 155 in FIG. 1, to generate the schedules which may be sent to the Schedule Manager MS 430.

According to some embodiments of the present disclosure, once the agent's manager approves the request, the SRM MS 420 may update the previously generated schedule in schedule manager MS 430, in case isFlexibleActivityRequest equals ‘false’.

According to some embodiments of the present disclosure, Schedule Manager MS 430, such as Schedule Manager MS 145 in FIG. 1, may handle all scheduling and staffing related functionalities. It may store, retrieve, and manage schedule data, net staffing data, and the configurations needed to generate schedules. When a user may initiate schedule generation, a request may be sent to the Schedule Manager MS 430 with the date range for which schedules are to be generated for the agents. On receiving this request, the Schedule Manager MS 430 may call an SRM Application Programming Interface (API) which may be associated with SRM MS 420 to get information about flexible activity requests made by agents. These activity requests may include details, such as the isFlexibleActivityRequest flag, activity name, start date, end date, start time, and end time for the activity.

According to some embodiments of the present disclosure, the Schedule Manager MS 430 may also fetch staffing data from a table, such as the STAFFING_DATA table in a database such as staffing data database 435 and such as staffing data database 160 in FIG. 1. This data may include information about the number of agents required for a specific time period and the number of agents available to work during that time.

According to some embodiments of the present disclosure, the Schedule Manager MS 430 may operate a Flexible Activity Request (FAR) evaluation. This process may involve analyzing the flexible activity requests, staffing data, and the schedule generation configurations to determine the best date and time to place the requested activity such that understaffing conditions may be minimized. It may be performed by matching the requests and staffing data to get the day that has least number of agents required.

According to some embodiments of the present disclosure, once the best date from the aspect of staffing levels has been determined, the Schedule Manager MS 430 may forward this information to a microservice, such as Scheduler MS 450 and such as Scheduler MS 155 in FIG. 1. Scheduler MS 450 may handle schedule generation jobs. The Scheduler MS 450 may use this information, along with other data, such as agent availability and schedule generation configurations. to generate schedules for the agents.

According to some embodiments of the present disclosure, the Schedule Manager MS 430 may ensure that the schedules are generated in compliance with the rules and regulations of the contact center and that the necessary data is available for the Scheduler MS 450 to perform its job effectively. It also makes sure that the flexible activities are placed on the date which is best suitable as per the staffing data and thus ensures efficient scheduling.

According to some embodiments of the present disclosure, Schedule Manager MS 430 may extract and package data. The Scheduler MS 430 may gather all the necessary data required for schedule generation. This includes data, such as agent availability, flexible activity requests, staffing data, and schedule generation configurations. The Scheduler MS 430 may submit jobs to batch in an on-demand cloud computing platforms and APIs, such as Amazon® Web Services (AWS) batch. The Scheduler MS 430 may use the AWS Batch to run scheduling generation jobs in parallel, to ensure that schedules are generated. It submits the jobs to AWS Batch, which then takes care of running the jobs on a cluster of an elastic compute cloud, such as Amazon® Elastic Compute Cloud (EC2) instances.

According to some embodiments of the present disclosure, Schedule Manager MS 430 may update job statuses. The Scheduler MS 450 may be responsible for monitoring the status of the scheduling generation jobs and for updating the status in real-time. This allows for the tracking of the progress of the scheduling generation process and helps in identifying any issues or errors that may occur.

According to some embodiments of the present disclosure, Schedule Manager MS 430 may consume scheduling results. Once the scheduling generation jobs have been completed, the Scheduler MS 430 may consume the results and may save the schedules to the Schedule Manager MS 430. It may also save any forecast or requirement data to the Schedule Manager MS 430. This ensures that the schedules are accurate and up-to-date.

According to some embodiments of the present disclosure, Schedule Manager MS 430 may receive the flexible activity, selected date and duration from the Schedule Manager MS 430 for which schedule needs to be generated for the agent. Based on this information, it generates schedules for the agents by taking into account their availability, flexible activities requested, staffing data, and schedule generation configurations. It also makes sure that the schedules are generated in compliance with the rules and regulations and are in line with the staffing data.

According to some embodiments of the present disclosure, Schedule Manager MS 430 may automate the schedule generation process, submit jobs to an on-demand cloud computing platforms and APIs, such as Amazon® Web Services (AWS) batch, update job statuses, and consume scheduling results. Schedule Manager MS 430 may ensure that schedules are generated efficiently and accurately, and that they are saved in the Schedule Manager MS 430 for future reference.

FIG. 5 is an example of a GUI 500 that enables an agent to enter a date range for the flexible activity request, in accordance with some embodiments of the present invention.

According to some embodiments of the present disclosure, in a system, such as computerized-system 100, an agent may enter a request for a future activity such as, time-off, self-paced training and the like. The request for future activity may be entered as either a fixed activity request or a flexible activity when the agent doesn't have any constraints on the day the activity may be scheduled.

According to some embodiments of the present disclosure, when the “Flexible Activity Request” option 510 is selected, instead of providing a single date for an activity request, the agent may enter a date range and may select from and to date to indicate the date range that the activity may be scheduled.

According to some embodiments of the present disclosure, optionally, the agent may also select the start and end time of the activity such that the activity may be placed within the specified time but on any one of the date range. The request may be initially forwarded to a manager or supervisor approval.

According to some embodiments of the present disclosure, before schedules may be generated in a WFM system, such as WFM system 110 in FIG. 1, the agent preferred range of dates may be considered and based on the agents demand as indicated by the staffing plan having staffing data, the activity may be scheduled on the date which would be selected by a module, such as Schedule Manager MS 145 in FIG. 1.

According to some embodiments of the present disclosure, after the schedules are generated, the agents and optionally their supervisor may be presented the requested activity on a selected date and optionally time along with the assigned schedules, for example, as shown in FIG. 11.

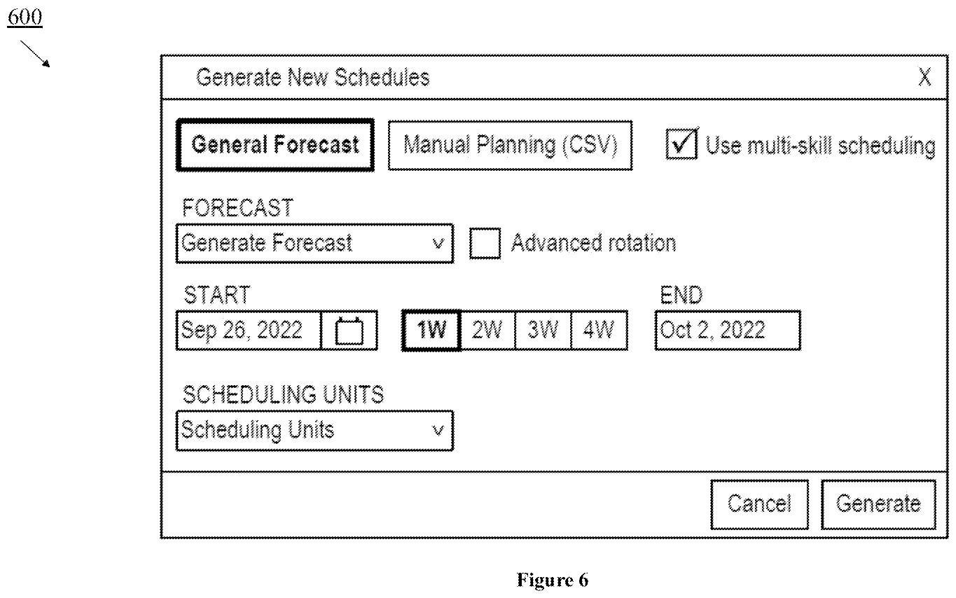

FIG. 6 is an example of a GUI 600 for a manager to initiate a schedule generation, in accordance with some embodiments of the present invention.

According to some embodiments of the present disclosure, in a system, such as computerized-system 100 in FIG. 1, a GUI, such as GUI 600 may be used by a user, such as a manager to initiate one or more schedule generation during a specified period. Agent flexible activity requests may be placed on the agent assigned schedule via a module, such as FAR module 120 in FIG. 1 which may communicate with other modules in the WFM system.

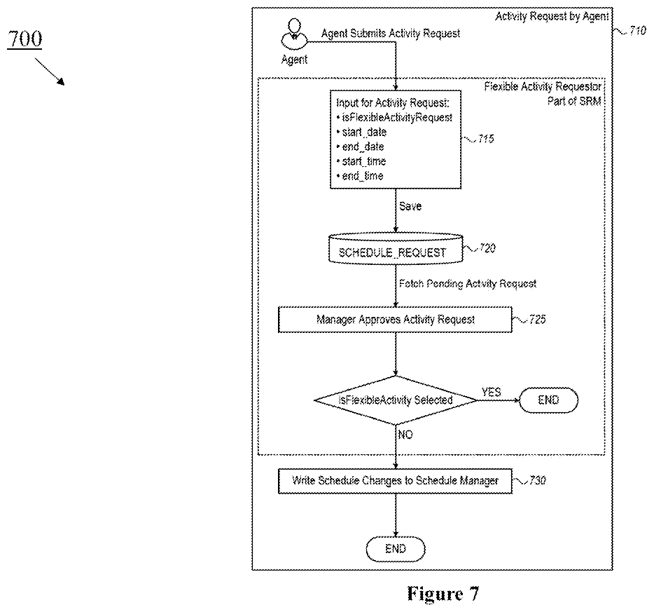

FIG. 7 is a schematic flowchart 700 of activity request submitted by an agent, in accordance with some embodiments of the present invention.

According to some embodiments of the present disclosure, Schedule Requests Manager (SRM) system 710, such as SRM system 140 in FIG. 1, which may operate a service, such as SRM MS 420 in FIG. 4, may relate to a Boolean flag isFlexibleActivitySelected, and other fields to capture the start and end dates, i.e., start_date and end_date 715, which may be included in the database, such as schedule-request database 720 and such as flexible activity request database 425 in FIG. 4. Optionally, start time and end time may be also entered by the agent for the future activity request.

According to some embodiments of the present disclosure, the Boolean flag isFlexibleActivitySelected may capture the agent's selection of whether they want the activity request to be a fixed or a flexible one. For example, element 510 in GUI 500 in FIG. 5, indicates that the activity request is a flexible one.

According to some embodiments of the present disclosure, a flexible activity request may be scheduled on any given date between a start date and end date as indicated by the agent when the agent entered the future activity request, for example via GUI 500 in FIG. 5. When element 510 in GUI 500 in FIG. 5 is checked by the agent, the Boolean flag isFlexibleActivitySelected may be set to ‘TRUE’, and the start and end dates entered by the agent may be captured in start_date and end_date. Other details of the future activity request may be captured as well.

According to some embodiments of the present disclosure, the future activity request may be sent to a manager approval and then upon manager approval 725 the activity may be displayed to the agent and embedded in an assigned schedule after the schedules are generated. The date of the future activity request may be selected by a schedule MS, such as schedule Manager MS 145 in FIG. 1 and such as scheduler MS 430 in FIG. 4.

According to some embodiments of the present disclosure, when the future activity request may be submitted by the agent with a ‘Flexible Activity Request’ option as unchecked, the isFlexibleActivitySelected flag may be set to ‘FALSE’ and may be stored in the database, such as schedule-request database 720. Schedule changes may be written to the Schedule Manager MS 730. and such as Schedule Manager MS 145 in FIG. 1 and such as Schedule Manager MS 430 in FIG. 4.

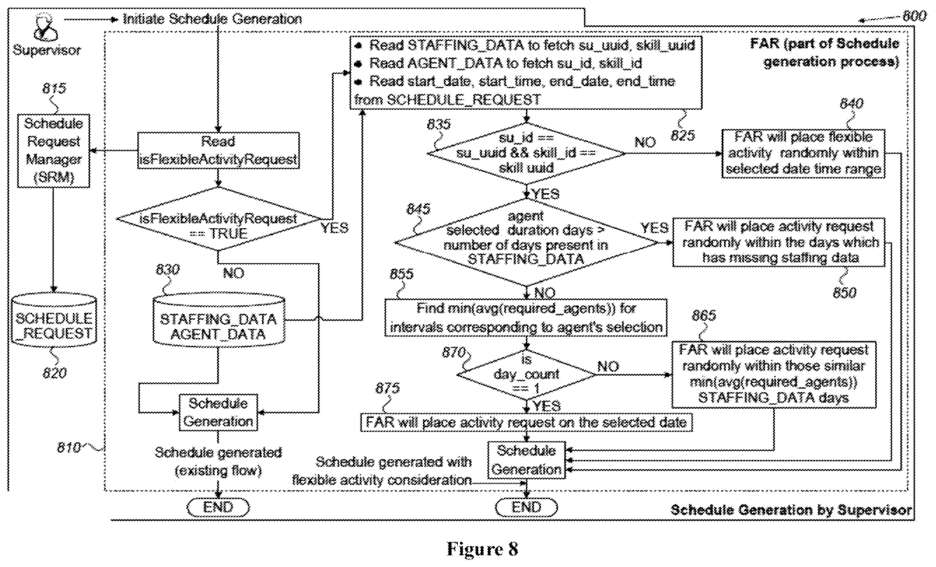

FIG. 8 is a schematic flowchart 800 of schedule generation by a supervisor, in accordance with some embodiments of the present invention.

According to some embodiments of the present disclosure, a user may initiate via a Workforce Manager (WFM) system, such as WFM system 110 in FIG. 1, a schedule generation process for a duration of 1/2/3 or 4 weeks, in order to generate the schedules for the agents based on staffing requirements. For example, via GUI 600 in FIG. 6.

According to some embodiments of the present disclosure, a module, such as flexible activity requestor (FAR) module 810 and such as FAR module 120 in FIG. 1, may be operated along with the schedule generation process. The FAR module 810 may read the value of the flag isFlexibleActivityRequest fetched from a table such as the SCHEDULE_REQUEST table in a database such as schedule-request database 820 and such as schedule-request database 720 in FIG. 7 within the SRM service of SRM system 140 in FIG. 1, and such as SRM MS 420 in FIG. 4.

According to some embodiments of the present disclosure, when the value of the flag isFlexibleActivityRequest equals ‘FALSE’, then no selection of date and optionally a time from a range will be required, and the schedule generation flow of the WFM system may be executed without the operation of the FAR module 810.

According to some embodiments of the present disclosure, when the value of the flag isFlexibleActivityRequest equals ‘TRUE’, then the FAR module 810 may communicate with the Schedule Manager MS, such as Schedule Manager MS 145 in FIG. 1, to fetch the Scheduling Unit (SU), i.e., a group of agents, skills and required agents, e.g., su_uuid, skill_uuid and required_agents from a table, such as STAFFING_DATA table in a database, such as staffing data database 160 in FIG. 1, and such as staffing data database 435 in FIG. 4.

According to some embodiments of the present disclosure, su_uuid may represent the scheduling unit, which is a group of agents. The skill_uuid may be the requirement of the skill for a given time period. The required_agents may represent the staffing requirement, i.e., the number of agents required. The STAFFING_DATA may provide the requirement of the number of agents for the given scheduling unit and skill type.

According to some embodiments of the present disclosure, the su_id and skill_id may be fetched from AGENT_DATA table in the database, such as staffing data database 160 in FIG. 1 and such as staffing data database 435 in FIG. 4. The su_id and skill_id is the scheduling unit of the agent and the skill that is assigned to the agent respectively.

According to some embodiments of the present disclosure, the fields from STAFFING_DATA and AGENT_DATA may be used by the FAR module 810. Upon a check if the staffing requirement for the given skill and scheduling unit 835, when the staffing requirement for the given skill and scheduling unit does not match against the agents scheduling unit and skill, which indicates there is no requirement for the agent on any given day between the start_date and end_date provided by the agent, the FAR module 810 may randomly schedule the activity for the agent on any given day between the start_date and end_date 840. Optionally, a time may be selected too from a provided range of time by the user.

According to some embodiments of the present disclosure, when the check of the staffing requirement for the given skill and scheduling unit matches against the agent's scheduling unit and skill it implies that there is a requirement for the agent, hence the FAR module 810 may compare number of agent's preferred days end_date-start_date and number of days for which the requirement is present in staffing data 840. The flexible activity requests which fall within the range of the Schedule Generation duration may be considered to be added to the schedules.

According to some embodiments of the present disclosure, when the check if the number_of_agent_selected_days is greater than the number_of_days_in_staffing data 845, then when the number_of_agent_selected_days is greater than the number_of_days_in_staffing_data it may imply that there are days where there is no requirement for the agent to be scheduled, so the FAR module 810 which communicates with the SRM system may schedule the activity a date randomly selected from any of the days which do not have a staffing requirement.

According to some embodiments of the present disclosure, when the number_of_agent_selected_days may be the number of days between start_date and end_date, the number_of_days_in_staffing_data may be number of days between the duration of schedule generation weeks selected, as shown for example, in FIG. 6, where there is a requirement for an agent from the same scheduling unit (su) and same skill as that of the agent who requested the flexible future activity request. For example, when the agent has selected a date range from Feb. 27, 2023 to Mar. 31, 2023, but in the staffing data, there is a requirement for the agent's skill and SU for dates between Feb. 27, 2023 and Feb. 28, 2023 only, then in that case any day between Mar. 1, 2023 and Mar. 3, 2023 may be selected for the activity to be placed as there is not requirement for that agent.

According to some embodiments of the present disclosure, when the check if the number_of_agent_selected_days is lower or equal to the number_of_days_in_staffing_data 845, then when the number_of_agent_selected_days is lower or equal to the number_of_days_in_staffing_data it may imply that there is a requirement for the agent for each requested date. The FAR module 810 which is communicating with the SRM system may evaluate which day has the least required_agents by using the following formula: least_required_agents_count=min(avg(required_agents)) against all the intervals between the activity request's start_time and end_time 855. The day_count may be calculated to be a number of days for which the value of the least_required_agents_count is the same.

According to some embodiments of the present disclosure, when the day_count may not equal to ‘1’, it may imply that there are more than one day where there is a minimum requirement. In such a case, the FAR module 810 may schedule the activity on any of these days 865. When the day_count is equal to ‘1’, it would imply that there is only one day which has the least required_agents and the FAR moduel 810 may schedule the activity on that day 875.

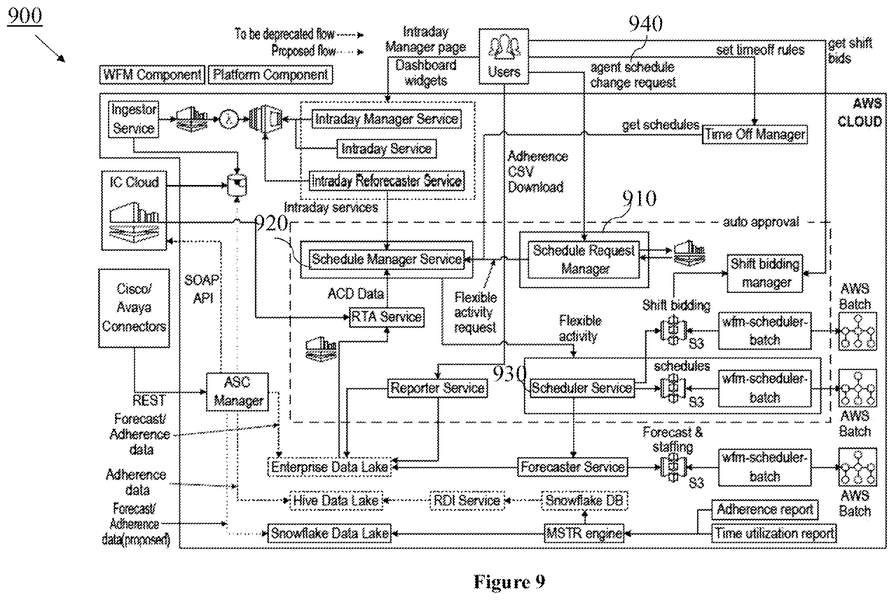

FIG. 9 is a Workforce Management system architecture diagram 900, in accordance with some embodiments of the present invention.

According to some embodiments of the present disclosure, a Schedule Requests Manager system 910, such as SRM system 140 in FIG. 1 and such as SRM system 420 in FIG. 4, may allow agents to request changes to their own schedules, and to allow for approvals and processing of requests for approval. These requests may include any activity request, such as time off and rescheduling which results in changes in the schedules of the agents. Once requests are approved by a user such as the manager, the SRM system may communicate with a Schedule Manager Microservice (MS) 920, such as Schedule Manager MS 145 in FIG. 1 and such as Schedule Manager MS 430 in FIG. 4, to persist the scheduling changes.

According to some embodiments of the present disclosure, the Schedule Manager MS 920, such as Scheduler MS 145 in FIG. 1 and such as Scheduler MS 430 in FIG. 4, may be the core application in the scheduling ecosystem. The Schedule Manager MS 920 may handle the storing and retrieval of schedule data, net staffing data, and all configurations required to generate schedules including daily rules, weekly rules, and activity codes.

According to some embodiments of the present disclosure, a Scheduler MS 930, such as Schedular MS 155 in FIG. 1 and such as Schedular MS 450 in FIG. 4 may handle the scheduling generation jobs. This includes extracting and packaging all data required for a schedule generation, submitting jobs to AWS Batch, updating job statuses, and consuming scheduling results by saving schedules and forecast or requirement data to schedule manager.

According to some embodiments of the present disclosure, batch may be a critical application that is run within AWS Batch. The Batch application runs the scheduler library and is handling the execution of schedule generation. Batch takes a “problem file” from a cloud object storage, such as Amazon® S3 as input and writes a “solution file” to the cloud object storage as an output. Triggers are setup on these buckets that notify the Scheduler MS 930 when the cloud object storage files are written to the input or output buckets.

According to some embodiments of the present disclosure, as the agent submits the flexible activity request, the agent schedule change request 940 may be triggered, which results in processing the information within the Schedule Request Manager (SRM) system 910. Once the activity request is approved by a user such as the manager, data may be sent from the FAR module, such as FAR module 120 in FIG. 1 to the Schedule Manager MS 920, such as Schedule Manager 145 in FIG. 1 and such as MS Schedule Manager MS 430 in FIG. 4.

According to some embodiments of the present disclosure, the following fields may be considered: isFlexibleActivitySelected, start date and end date. Once a user, such as a supervisor may initiate a schedule generation process the fields mentioned above may be utilized by the Scheduler MS 930 and the wfm_scheduler_batch job may be triggered which may utilize this information to generate the schedules by placing the activity between a date selected by the user as the input. The date may be selected by details provided by the FAR module.

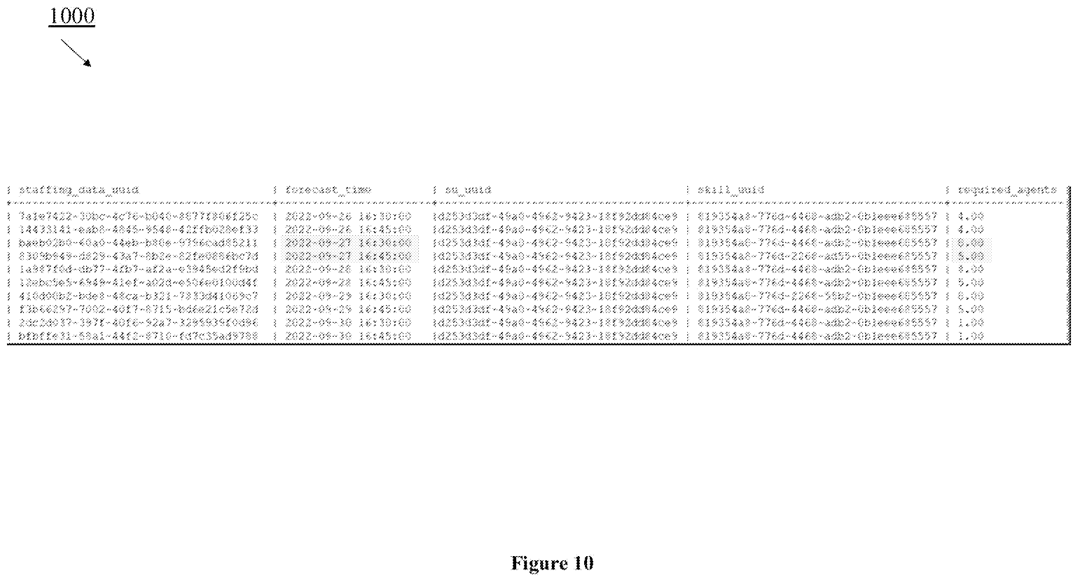

FIG. 10 is an example of a table of agents requirement in a date range 1000, in accordance with some embodiments of the present invention.

According to some embodiments of the present disclosure, an evaluation of the best day to select from the range of dates provided by the agent when the future activity request has been entered by a module such as the FAR module 120 in FIG. 1, may be operated.

According to some embodiments of the present disclosure, the staffing data may be provided as an input to the schedule generation process. Staffing data may include the number of agents required for a given scheduling unit and skill for every preconfigured time, e.g., 15 mins duration wherever the staffing is required. For example, for a given date range of Sep. 26, 2022, to Sep. 30, 2022, with a fixed time period of 16:30 to 17:00, the number of agents required for a given scheduling unit and skill may be denoted by required_agents. Since on Sep. 30, 2022, the required_agents are the least, which is ‘1’, while on other days required_agents are more than ‘1’. The FAR module, such as FAR module 120 in FIG. 1, may communicate with other components in the WFM system to choose Sep. 30, 2022, to schedule the flexible activity since the staffing requirement may be least affected, as presented in FIG. 11.

FIG. 11 is an example of a GUI 1100 that presents a schedule and an activity embedded therein, in accordance with some embodiments of the present invention.

According to some embodiments of the present disclosure, GUI 1100 is an example of a schedule of an agent where a date for an activity has been selected as a response to agent future activity request.

According to some embodiments of the present disclosure, a schedule for Sep. 30, 2022, may include a break at 10:45 am for 45 minutes and at 3:30 pm for 15 minutes. A flexible activity request which may have been entered by an agent via a GUI such as GUI 500 in FIG. 5, by an FAR module 120 in FIG. 1 in a computerized-system 100 in FIG. 1, may have been communicating with other components in WFM system to select that date of Sep. 30, 2022, at 4:30 pm.

It should be understood with respect to any flowchart referenced herein that the division of the illustrated method into discrete operations represented by blocks of the flowchart has been selected for convenience and clarity only. Alternative division of the illustrated method into discrete operations is possible with equivalent results. Such alternative division of the illustrated method into discrete operations should be understood as representing other embodiments of the illustrated method.

Similarly, it should be understood that, unless indicated otherwise, the illustrated order of execution of the operations represented by blocks of any flowchart referenced herein has been selected for convenience and clarity only. Operations of the illustrated method may be executed in an alternative order, or concurrently, with equivalent results. Such reordering of operations of the illustrated method should be understood as representing other embodiments of the illustrated method.

Different embodiments are disclosed herein. Features of certain embodiments may be combined with features of other embodiments; thus, certain embodiments may be combinations of features of multiple embodiments. The foregoing description of the embodiments of the disclosure has been presented for the purposes of illustration and description. It is not intended to be exhaustive or to limit the disclosure to the precise form disclosed. It should be appreciated by persons skilled in the art that many modifications. variations, substitutions, changes, and equivalents are possible in light of the above teaching. It is, therefore, to be understood that the appended claims are intended to cover all such modifications and changes as fall within the true spirit of the disclosure. While certain features of the disclosure have been illustrated and described herein, many modifications, substitutions, changes, and equivalents will now occur to those of ordinary still in the art. It is, therefore, to be understood that the appended claims are intended to cover all such modifications and changes as fall within the time spirit of the disclosure.

What is claimed:

1. A computerized-method for reducing understaffing conditions by enabling scheduling of a flexible activity request in a Workforce Management (WFM) system, said computerized-method comprising:
(i) operating a Flexible Activity Requestor (FAR) module to enable an agent to enter a date range for the flexible activity request via a Graphical User Interface (GUI);
(ii) receiving agent date range for a future activity request to be forwarded to a Schedule Requests Management (SRM) system and upon manager approval stored in a database of agents preferences;
(iii) generating one or more schedules in a preconfigured period to be assigned to one or more agents, and forwarding the generated schedules to a Schedule Manager Microservice (MS);
(iv) having the SRM system retrieve preferences of future activity requests in the preconfigured period from the database of agents preferences and forward it to the Schedule Manager MS;
(v) operating a scheduler MS to select a date which is in the entered date range for each future activity request of the one or more future activity requests based on: a. the retrieved preferences of future activity requests; and b. staffing plans retrieved from a staffing data database; and
(vi) sending notifications to agents as to the selected date of each future activity request of the one or more future activity requests,
wherein each notification in the notifications includes the flexible activity request in the selected date in an assigned schedule in the WFM system,
thus, by taking into account staffing plans when selecting a date for an activity, reducing understaffing conditions in a contact center which results in increased wait time for customers.

2. The computerized-method of claim 1, wherein the operating of the FAR module is enabled by a selection of an option for the FAR module in a Graphical User Interface (GUI) that is associated to the FAR module.

3. The computerized-method of claim 1, wherein the FAR module is configurable.

4. The computerized-method of claim 1, wherein a future activity request is selected from at least on of: (i) time-off; (ii) self-paced training; (iii) any other activity which requires one agent involvement.

5. The computerized-method of claim 1, wherein the notifications are sent by email messages to the agents.

6. The computerized-method of claim 1, wherein the generating of the one or more schedules in the preconfigured period to be assigned to one or more agents is operated by the FAR module and comprising for each agent that has one or more future activity requests in the preconfigured period which are stored in the database of agents preferences:
(i) retrieving staffing data from the staffing data database for each schedule in the preconfigured period, said staffing data comprising a required number of agents and available agents;
(ii) when the available agents for the staffing data is greater than the required number of agents for the staffing data for each schedule in the one or more schedules, then randomly selecting a date for each future activity request of the one or more future activity requests;
(iii) when the available agents for the staffing data is lower than the required number of agents for the staffing data in one or more schedules, then randomly selecting a date that is in the date range for the flexible activity request and not in a date that the available agents for the staffing data is lower than the required number of agents for the staffing data, for the future activity request; and
(iv) when the available agents for the staffing data is lower than the required number of agents for the staffing data in all one or more schedules, then selecting a date that is in the date range for the flexible activity request and that is least understaffed for the future activity request.

7. The computerized-method of claim 6, wherein each selected date for each future activity request is published in a related schedule via the GUI.

8. The computerized-method of claim 6, wherein staffing data comprising at least one of: (i) scheduling unit group of agents; and (ii) one or more skills required for a schedule.

9. The computerized-method of claim 1, wherein the selected date for the future activity request is embedded in the assigned schedule in the WFM system.

10. A computerized-system for reducing understaffing conditions by enabling scheduling of a flexible activity request in a in a Workforce Management (WFM) system, said computerized-system comprising:
one or more processors;
a database of agents preferences; a staffing data database, and a memory to store the plurality of databases, said one or more processors are configured to:
(i) operate a Flexible Activity Requestor (FAR) module to enable an agent to enter a date range for the flexible activity request upon agent selection to operate an FAR module via a Graphical User Interface (GUI);
(ii) receive agent date range for a future activity request to be forwarded to a Schedule Requests Management (SRM) system and upon manager approval stored in a database of agents preferences;
(iii) generate one or more schedules in a preconfigured period to be assigned to one or more agents, and forwarding the generated schedules to Schedule Manager Microservice (MS);
(iv) have the SRM system retrieve preferences of future activity requests in a preconfigured period from the database of agents preferences and forward it to the Schedule Manager MS;
(v) operate a scheduler MS to select a date which is in the entered date range for each future activity request of the one or more future activity requests based on: a. the retrieved preferences of future activity requests; and b. staffing plans retrieved from the staffing data database; and
(vi) send notifications to agents as to the selected date of each future activity request of the one or more future activity requests, wherein each notification in the notifications includes the flexible activity request in the selected date in an assigned schedule. thus, by taking into account staffing plans when selecting a date for an activity, reducing understaffing conditions in a contact center which results in increased wait time for customers.
